(19) United States
(12) Patent Application Publication
(10) Pub. No.: US 2017/0124246 A1
(43) Pub. Date: May 4, 2017

(54) SYSTEM AND METHOD FOR DESIGNING A PRINTED CIRCUIT BOARD

(71) Applicant: HEWLETT PACKARD ENTERPRISE DEVELOPMENT LP, Houston, TX (US)

(72) Inventors: Melvin K. Benedict, Magnolia, TX (US); Brian T. Purcell, Tomball, TX (US); Robert Allen Voss, Houston, TX (US); Scott M. Kogut, Houston, TX (US)

(21) Appl. No.: 15/316,026

(22) PCT Filed: Jul. 30, 2014
(86) PCT No.: PCT/US14/48938

§ 371 Date: Dec. 2, 2016

(51) Int. Cl. G06F 17/50

(52) U.S. Cl. CPC G06F 17/5077

(57) ABSTRACT

A method is described in which a functional region on a printed circuit board (PCB) is defined, a regional circuit design to be inserted into the functional region on the PCB is selected, and the regional circuit design is pasted into the functional region.

### BACKGROUND

A standard printed circuit board (PCB) may contain a matrix of configurable functional logic blocks surrounded by a periphery of input/output (I/O) blocks. Electrical signals may be routed between the functional logic blocks and the I/O blocks via interconnect traces and wiring. In many PCB fabrication techniques, it is commonplace to reuse the functional logic blocks across various PCB designs. In particular, an unchanged functional logic block may be reused in varied PCB design configurations.

### BRIEF DESCRIPTION OF THE DRAWINGS

Certain examples are described in the following detained description and in reference to the drawings, in which:

FIG. 1A is a block diagram of an example of a computer system to design a printed circuit board (PCB);

FIG. 1B is a simplified block diagram of the example of the computer system to design the PCB;

FIG. 2 is an example of a screen shot of a design interface for a PCB design, including a functional region circuit selector;

FIG. 3 is an example of another screen shot of a design interface for a PCB design, to enable the selection of a processor circuit design;

FIG. 4 is an example of a screen shot of a design interface for a PCB design, to enable a selection of a memory circuit design;

FIG. 5 is an example of a screen shot of a design interface for a PCB design, to enable the selection of an input/output (I/O) circuit design;

FIG. 6 is an example of a customized PCB, after populating functional regions; and

FIG. 7 is a block diagram of a method for designing a customized PCB.

### DETAILED DESCRIPTION

The reuse of printed circuit board (PCB) designs may preserve the logical circuit representations of an initial PCB design, for example, for the fabrication of other PCBs. However, current techniques for reusing PCB designs do not provide flexible changes to the logical circuit representations. As a result, the initial PCB design merely allows the designer to reuse, and not replace, a logical block (e.g., memory logical block, processor logical block, I/O logical block), since changes to the logical block may not be feasible.

Examples described herein describe a method of designing a PCB including defining a functional region where circuit traces may be mapped to predetermined locations at the edge of the functional region. The method may allow a designer to select and paste a particular regional circuit design into the functional region to create a PCB design. Using the same PCB design, varied regional circuit designs, for example, different types of memory, processors, and input/output blocks, may be pasted into the functional region to create other PCB designs. The bit, or circuit traces, mapped at the edges of the functional region will remain substantially the same for each logical block design. Thus, the positions of the circuit traces for equivalent bit numbers may have the same position for each type of memory logical block, processor logical block, I/O logical block, and the like. This mapping allows for efficient generation of new PCBs to be created from an initial PCB design, by substituting alternate logical blocks.

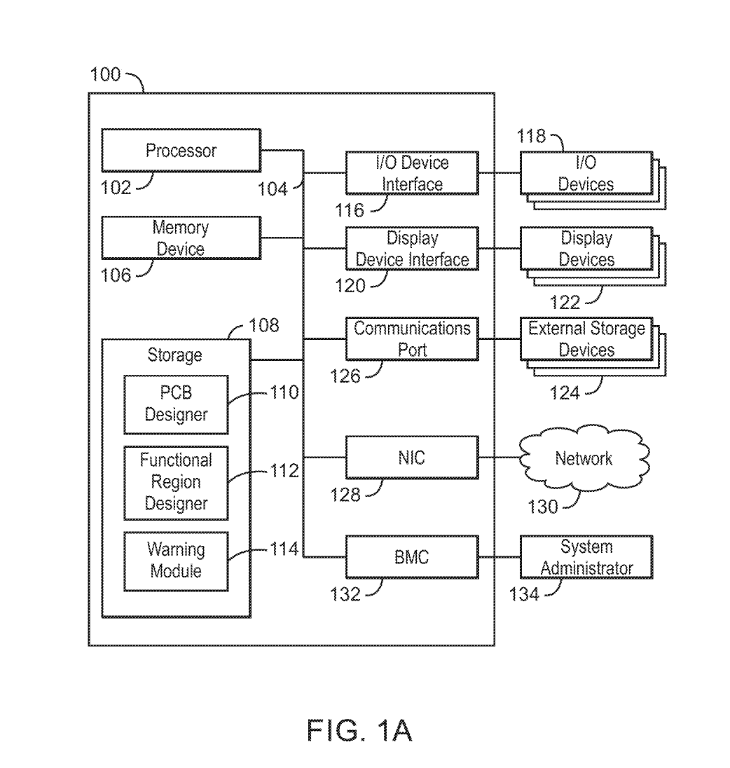

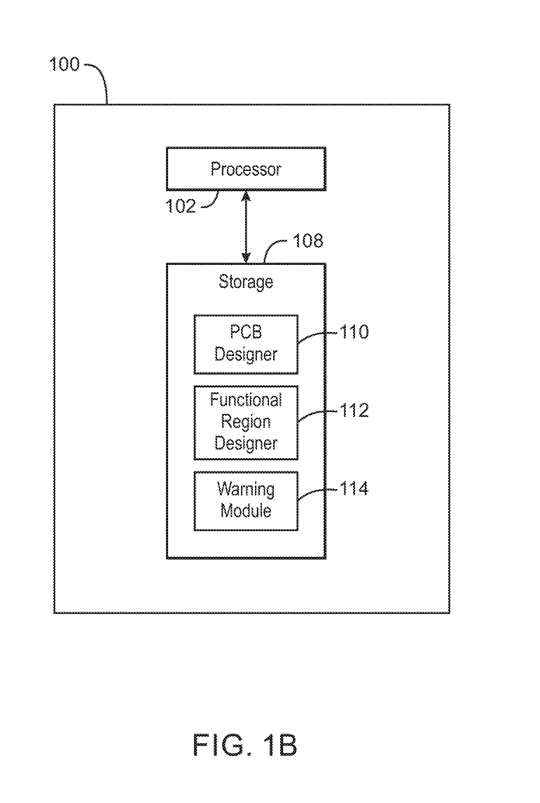

FIG. 1A is a block diagram of an example of a computer system 100 to design a PCB. The computing system 100 may include, for example, a server computer, a mobile phone, laptop computer, desktop computer, or tablet computer, among others. The computing system 100 may include a processor 102 that is adapted to execute stored instructions. The processor 102 can be a single core processor, a multi--core processor, a computing cluster, or any number of other appropriate configurations.

The processor 102 may be connected through a system bus 104 (e.g., AMBA®, PCI®, PCI Express®, Hyper Transport®, or Serial ATA, among others) to a memory device 106. In some examples, the memory device 106 can include random access memory (e.g., SRAM, DRAM, eDRAM, EDO RAM, DDR RAM, RRAM®, or PRAM, among others), read only memory (e.g., Mask ROM, EPROM, or EEPROM, among others), non-volatile memory (PCM, STT_MRAM, ReRAM, Memristor), or any other suitable memory systems.

The processor 102 may be linked through the system bus 104 to a storage device 108. The storage device 108 may contain a PCB designer 110, a functional region designer 112, and a warning module 114. The PCB designer 110 may be utilized to initially create a PCB design. The PCB design may thereafter be used to create a PCB, which mechanically supports and electrically connects electronic components using electrical interconnects. The PCB designer 110 may allow a designer to input the physical dimensions of the PCB design and to route electrical interconnections, e.g., traces, wiring, pads, on the PCB design. For example, the PCB designer 110 may define the number of via holes within the PCB design or the size and shape of the PCB design. The PCB designer 110 may also outline various locations for the addition of functional blocks.

Accordingly, the storage device 108 may contain a functional region designer 112. The functional region designer 112 may be used to define the circuits that may be used in various functional regions including a processor region, a memory region, and an I/O block region, among other functional logic regions. Such functional regions may be defined as the hardware circuits necessary to implement the operations of the computing system 100. A designer may select any number of functional regions to build the foundation of the PCB design. Additionally, electrical interconnections at the edge of the functional region may include predetermined locations, where electrical interconnections of a regional circuit design, e.g., a memory type, processor type, I/O block type, may be mapped to the predetermined locations.

The storage device 108 may contain a warning module 114. The warning module 114 may provide warning signals related to electrical connectivity, trace widths, functional region spacing, and power failure, among other PCB design problems or failures. For example, the warning module 114 may alert the designer to an incomplete mapping between regional circuit designs, e.g., memory circuit, processor circuit, I/O block circuit. Further, the warning module 114 may suggest circuitry, such as bit shifting circuits, to allow the use of circuits having different bit widths to be interconnected.

The processor 102 may be connected through the system bus 104 to an input/output (I/O) device interface 116 adapted to connect the computing system 100 to one or more I/O devices 118. The I/O devices 118 may include, for example, a keyboard and a pointing device, wherein the pointing device may include a touchpad or a touchscreen, among others. The 110 devices 118 may be built-in components of the computing system 100, or may be devices that are externally connected to the computing system 100.

The processor 102 may also be linked through the system bus 104 to a display device interface 120 adapted to connect the computing system 100 to display devices 122. The display devices 122 may include a display screen that is a built-in component of the computing system 100. The display devices 122 may also include computer monitors, televisions, or projectors, among others, that are externally connected to the computing system 100.

The processor 102 may be linked through the system bus 104 to an external storage device 124 via a communications port 126 to expand the storage capacity of the computing system 100, to back up or to share data, among other purposes.

The processor 102 may be linked through the system bus 104 to a network interface card (NIC) 128. The NIC 128 may connect the computing system 100 to a network 130, including a wide area network (WAN), local area network (LAN), or the Internet, among others.

The processor 102 may be linked through the system bus 104 to a baseboard management controller (BMC) 132. The BMC 132 is a service processor that monitors the physical state of the computing system 100 using sensors and communicates with a system administrator 134 through an independent connection. The sensors of the BMC 132 may measure internal physical variables such as temperature, humidity, power-supply voltage, fan speeds, communications parameters, and operating system (OS) functions. If any of these variables stray outside of specified limits, the system administrator 134 may be notified.

The block diagram of FIG. 1A is not intended to indicate that the computing system 100 includes all of the components shown in FIG. 1A. Further, the computing system 100 may include any number of additional components not shown in FIG. 1A, depending on the details of the specific design and implementation.

FIG. 1B is a simplified block diagram of the example of the computer system 100 to design the PCB. Like numbers are as described with respect to FIG. 1A. In this simplified example of the computer system 100, a processor 102 is linked to a storage device 102 to execute the processes stored in the storage device 102 for designing a printed circuit board.

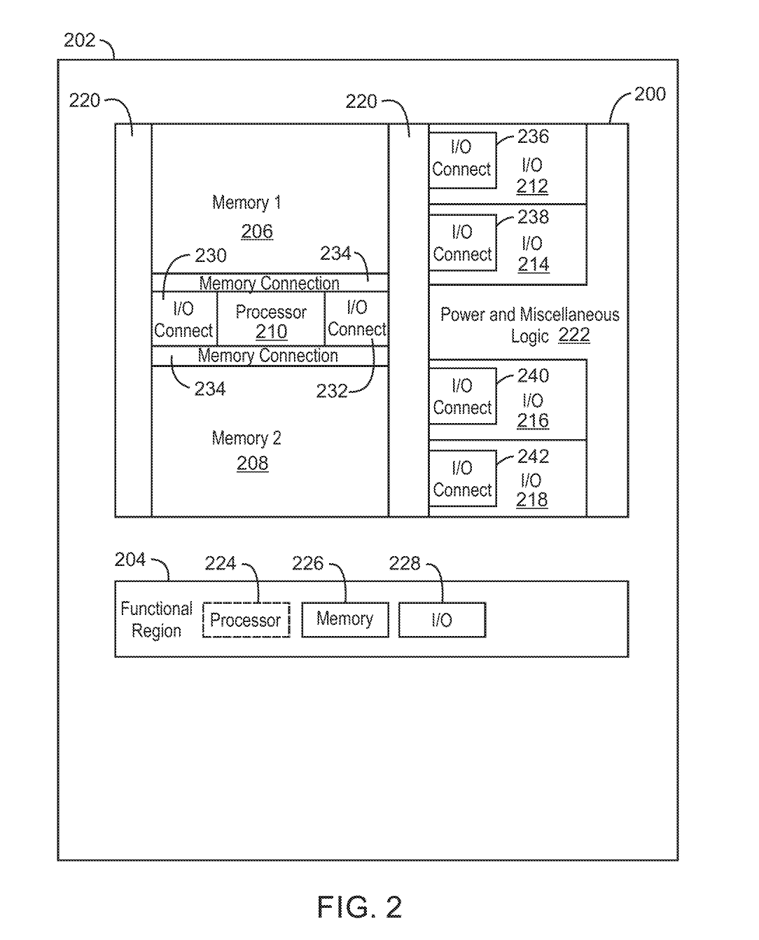

FIG. 2 is an example of a screen shot 200 of a design interface for a PCB design 202, including a functional region circuit selector 204. The PCB design 202 may include various functional regions. A functional region may be a predefined logical entity that is designated for a specific function within a computing system. As shown in FIG. 2, the functional regions of the PCB design 202 may include a memory 1 functional region 206, memory 2 functional region 208, processor functional region 210, and I/O block functional regions 212, 214, 216, and 218. Additionally, several fixed signal locations may be included on the PCB design 202, including a system bus section 220 and a power section 222, e.g., power control, power logic.

To accommodate electrical connectivity, circuit traces for each of the functional regions 206, 208, 210, 212, 214, 216, 218 may be mapped to predetermined locations at the edge of each functional region. As an example, the circuit traces for address bits may be mapped along one region at the edge of a functional region, while the circuit traces for data bits may be mapped along another region. For functional regions with narrower bit widths, the circuit traces for lower bit numbers may be mapped to the same predetermined locations, while circuit traces for higher bit numbers may be omitted.

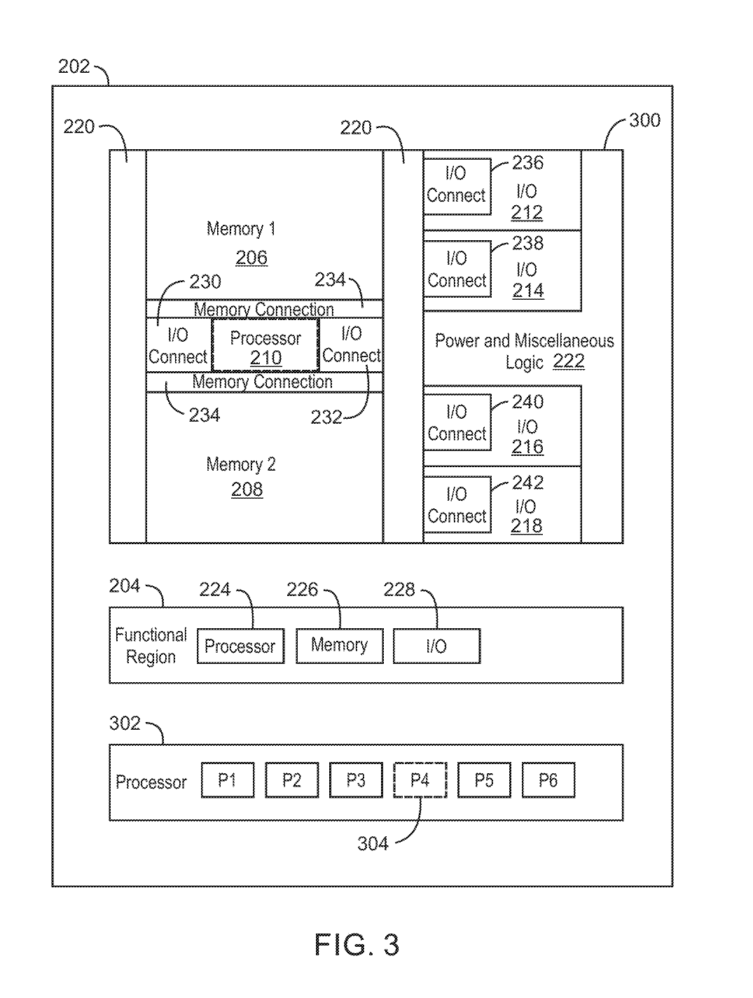

As an example of a system that may be used for the PCB design 202, a display may show the functional region circuit selector 204 in close proximity to the screen shot 200. The functional region circuit selector 204 may allow the designer to select a regional circuit design for a functional region e.g., a processor circuit 224, memory circuit 226, or I/O block circuit 228, among others. For example, the designer may choose to insert a desired support circuit into the processor functional region 210. Accordingly, the designer may initially select the processor circuit 224 from the functional region circuit selector 204, which supports a chosen processor type, as will be discussed in greater detail with respect to FIG. 3. Since the processor functional region 210 may include circuit traces mapped to predetermined locations, it may accept regional circuit designs of various bit widths.

Each regional circuit design may be pre-validated for use in the functional regions before it is inserted. In particular, each regional circuit design may be validated using functional tests, e.g., operational parameters, electrical parameters, and logical parameters, to verify its integrity in the PCB design.

As depicted in FIG. 2, the processor functional region 210 may have adjacent I/O connects 230, 232. An I/O connect may act as a port to allow a cable from a circuit, located elsewhere in the system, or an external plug to be plugged into the PCB. The memory functional region 206, 208 may be electrically connected to other functional regions and logic components via a memory connection region 234. The PCB design 202 may contain more I/O connects 236, 238, 240, 242 associated with I/O block functional regions 212, 214, 216, 218, respectively. The I/O blocks 212, 214, 216, 218 may or may not be all the same shape. However, the shape may be restricted such that various combinations can fit together with minimum spacing remaining on the PCB design 202.

FIG. 3 is an example of a screen shot 300 of a design interface for a PCB design 202, to enable the selection of a processor circuit design. Like numbers are as described with respect to FIG. 2. Upon selecting a processor circuit design 224, a processor interface menu 302 may display various support circuits for different processor types, e.g., P1-P6, so that the designer may select a preferred processor support circuit. For example, the designer may select a support circuit for a particular processor, e.g., P4, by either double-clicking or clicking and dragging it to the processor functional region 210. On the display of the processor interface menu 302, the preferred processor support circuit 304 may be highlighted, bolded, or enlarged, among other techniques, in order to identify the selection. The preferred processor support circuit 304 may then populate the processor functional region 210.

The selections chosen from the functional region circuit selector 204 and the processor interface menu 302 may depend on the preferences of the designer including overall platform needs, performance requirements, and storage allocation, among others. Thus, the preferred processor support circuit 304 may not be a permanent design choice. Instead, the designer may change the original selection and select another type of processor support circuit.

With respect to FIG. 2, the processor functional region 210 may include circuit traces that are mapped to predetermined locations at the edge of the region 210. Since the locations are predetermined to accommodate varying processor bit widths, the designer may have the option of both reusing the existing PCB design and inserting a processor support circuit different from the previous processor support circuit associated with the existing PCB design. For example, an existing PCB design may include a 32-bit processor. To reduce the time from customer request to delivery, the designer may choose to reuse the existing PCB design with a 16-bit processor or a 64-bit processor. Thus, the designer may select a new processor support circuit, which supports either the 16-bit or 64-bit processor type, for the processor functional region 210 of the existing PCB design. Accordingly, the new processor support circuit may be automatically pasted into the correct processor functional region to support the chosen processor type. Further, additional circuitry may be added to the existing circuit traces that may be mapped to the predetermined locations. For example, with the insertion of a 64-bit processor, additional circuit traces may be added to the existing circuit traces to provide effective interfacing with the 64-bit processor, which has more circuit traces. As a result, the designer may reduce PCB development time through the reuse of a validated functional region by replacing an existing processor with other processors of varying bit sizes. Accordingly, the PCB design 202 provides the designer with numerous PCB design choices without having to expend additional engineering efforts and time.

The designer may reserve spacing for a functional region on the PCB design 202 to accommodate a maximum bit-width of a regional circuit design. Moreover, while the design of the PCB may change, the predetermined locations may not generally change since they are an inherent component of a selected circuit design. Thus, as previously discussed, the location of the circuit traces may be mapped to the same location in every PCB design.

Additionally, the edges of the PCB board may become non-uniform in areas located outside of the functional region during processing. As a result, the edges of the PCB may need to be cleaned after fabrication using edge-cleaning techniques including etching, filing, shearing, and milling, among others.

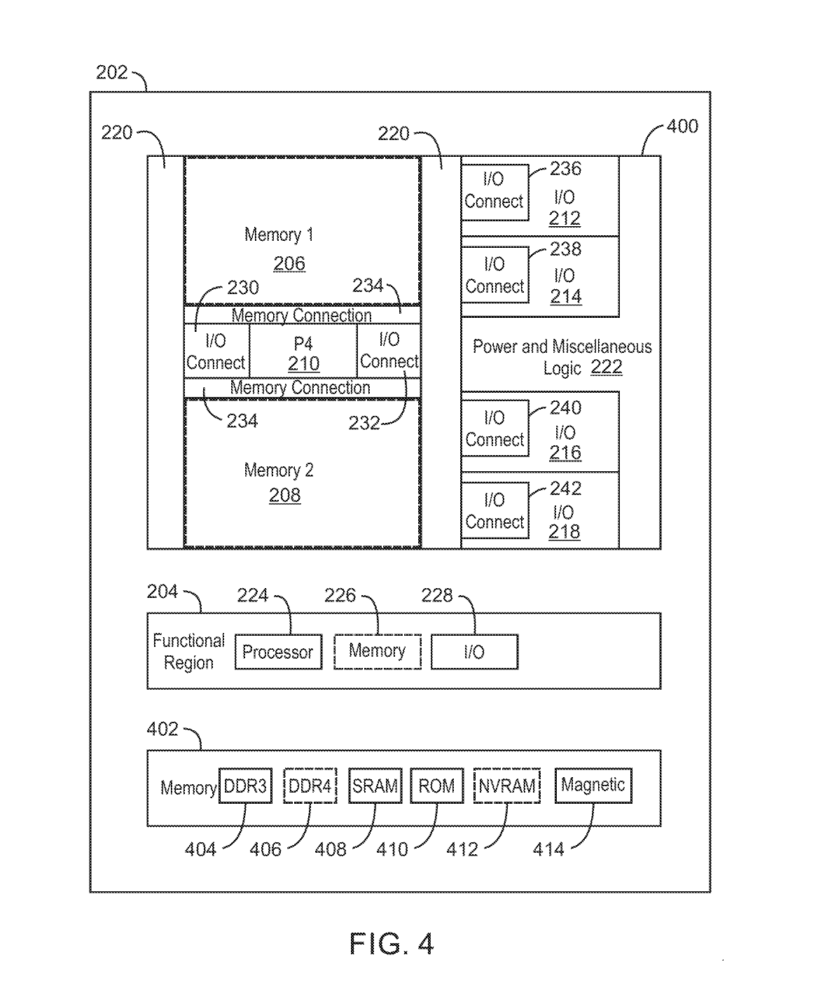

FIG. 4 is an example of a screen 400 shot of a design interface for a PCB design 202, to enable a selection of a memory circuit design. Like numbers are as described with respect to FIG. 2. The designer may utilize the functional region circuit selector 204 to select a memory circuit 226 to populate a memory functional region 206, 208. Upon selecting a memory circuit design 226, a memory interface menu 402 may display various support circuits for different memory types, e.g., a double data rate type third synchronous dynamic random access memory (DDR3) 404, double data rate type fourth synchronous dynamic random access memory (DDR4) 406, static random-access memory (SRAM) 408, read-only memory (ROM) 410, non-volatile random-access memory (NVRAM) 412, and magnetic memory 414, among other memory circuit types. Accordingly, the designer may choose a preferred memory support circuit. For example, the designer may select a support circuit for a particular memory, e.g., DDR4 406 and NVRAM 412, by either double-clicking or clicking and dragging it to the memory functional region 206, 208. On the display of the memory interface menu 402, the preferred memory support circuit 406, 412 may be highlighted, bolded, or enlarged, among other techniques, in order to identify the selection. The preferred memory support circuit 406, 412 may then populate the memory functional region 206, 208.

Although FIG. 4 shows both memory regions 206, 208 populated, the designer may individually populate memory functional region 206 or memory functional section 208. If only one memory functional region is chosen, the unchosen memory functional region may be omitted from the PCB design 202. In an example, the unchosen memory functional region may be repurposed for other types of logical entities on the PCB design 202.

The memory functional region 206, 208 of the PCB design 202 may include circuit traces that are mapped to predetermined locations at the edge of the memory functional region 206, 208. Thus, the predetermined locations of the memory functional region 206, 208 may accommodate a wide range of memory bit widths since the predetermined locations may be added or removed based on the type of memory selected.

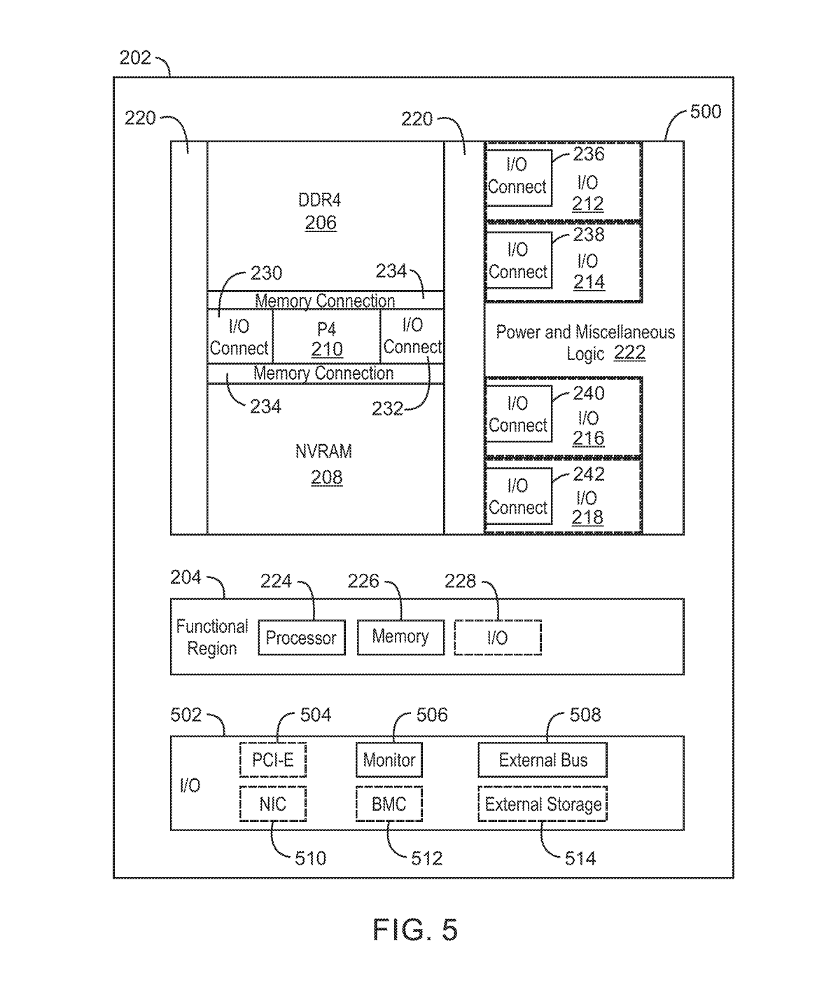

FIG. 5 is an example of a screen shot 500 of a design interface for a PCB design 202, to enable the selection of an input/output (I/O) circuit design. Like numbers are as described with respect to FIG. 2. The designer may utilize the functional region circuit selector 204 to select an I/O circuit design 228 to populate an I/O functional region 212, 214, 216, 218. Upon selecting the I/O circuit 228, an I/O block interface menu 502 may appear to display various I/O support circuits for different I/O block types, e.g., PCI-E 504, monitor 506, external bus 508, NIC 510, BMC 512, and external storage 514, among other computer hardware.

The designer may select a preferred I/O support circuit for a particular I/O block, e.g., 504, 510, 512, 514, by either double-clicking or clicking and dragging it to the I/O functional region 212, 214, 216, 218 to populate the region. The designer may have the option of populating less than all of the I/O functional regions. As a result, any unchosen I/O functional regions may be omitted, or may be used for other types of logical entities on the PCB design 202.

The I/O functional region 212, 214, 216, 218 of the PCB design 202 may include circuit traces that are mapped to predetermined locations at the edge of the region 212, 214, 216, 218. Thus, the predetermined locations of the I/O functional region 212, 214, 216, 218 may accommodate a wide range of I/O bit widths associated with various I/O block circuit designs.

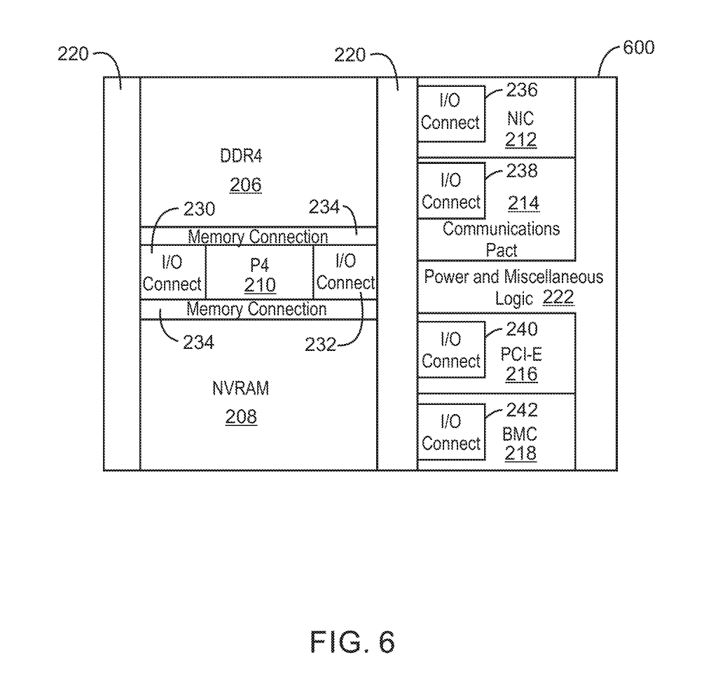

FIG. 6 is an example of a customized PCB 600, after populating functional regions. The customized PCB 600 may include functional regions populated by various support circuits including a DDR4 206, NVRAM 208, processor P4 210, MC 212, Communications Port 214, PCI-E 216, and BMC 218.

Each functional region of the customized PCB 600 may include predetermined locations to accommodate varying regional circuit design bit widths. Thus, if the designer chooses to reuse the customized PCB 600 in another PCB, the different types of support circuit designs may be replaced in the functional regions. For example, the designer may select and insert a support circuit design of a different type from the previous support circuit design for the same functional region. As a result, the designer may reduce PCB development and delivery time through the reuse of a functional region with predetermined locations located along its perimeter.

The customized PCB 600 depicted in FIG. 6 is not intended to indicate the design include only the logical blocks depicted. Instead, the customized PCB 600 may include or remove any number of logical blocks, depending on the details of the specific design and implementation.

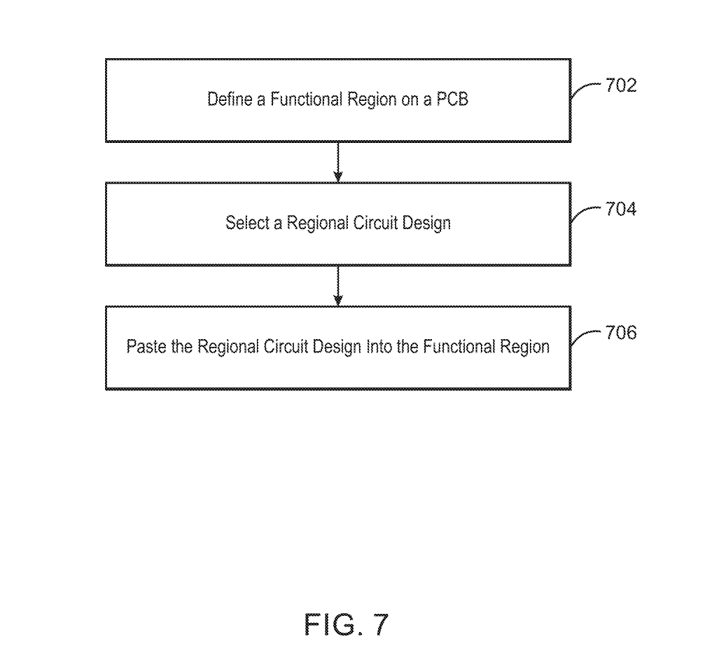

FIG. 7 is a block diagram of a method for designing a customized PCB. At block 702, a functional region may be defined on a PCB. Circuit traces may be mapped to predetermined locations at the edge of the functional region. The number of predetermined locations may be added or deleted based on the technology associated with PCB usage. At block 704, a regional circuit design from a plurality of design choices may be inserted into the functional region on the PCB. The regional circuit design may include circuit traces that may be mapped to the predetermined locations at the edge of the functional region. At block 706, the regional circuit design may be pasted into the functional region to design a customized PCB.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for designing a printed circuit board (PCB), comprising:
defining a functional region on a PCB, wherein circuit traces are mapped to predetermined locations at the edge of the functional region;
selecting a regional circuit design from a plurality of design choices to be inserted into the functional region on the PCB; and
pasting the regional circuit design into the functional region to create a PCB design, wherein the regional circuit design comprises circuit traces that are mapped to the predetermined locations.

2. The method of claim 1, comprising aligning the predetermined locations to accommodate regional circuit designs of various bit widths.

3. The method of claim 1, comprising adding circuit traces to the functional region with fewer circuit traces to allow effective interfacing with a regional circuit design having more circuit traces.

4. The method of claim 1, comprising reserving space in the functional region to accommodate the maximum bit width of a regional circuit design.

5. The method of claim 1, comprising implementing a warning module to signal occurrences related to PCB design failures.

6. A computing system, comprising
a storage module to provide instructions to design a printed circuit board (PCB); and
a processor to execute the instructions provided by the storage module, wherein the instructions direct the processor to:
define a functional region on a PCB, wherein circuit traces are mapped to predetermined locations at the edge of the functional region;
select a regional circuit design from a plurality of design choices to be inserted into the functional region on the PCB; and
paste the regional circuit design into the functional region to create a PCB design, wherein the regional circuit design comprises circuit traces that are mapped to the predetermined locations.

7. The computing system of claim 6, wherein the predetermined locations accommodate regional circuit designs of various bit widths.

8. The computing system of claim 6, wherein the functional region includes reserve spacing to accommodate the maximum bit width of a regional circuit.

9. The computing system of claim 6, wherein a selection of the regional circuit design determines the width of bit traces for the PCB.

10. The computing system of claim 6, wherein the number of circuit traces may be increased or decreased based on the number of circuit traces of the regional circuit design.

11. The computing system of claim 6, wherein the edges of the PCB board are non-uniform in areas located outside of the functional region.

12. The computing system of claim 6, comprising a plurality of functional regions, wherein less than all of the functional regions are populated on the PCB.

13. A customized printed circuit board (PCB), comprising
a functional region on a PCB comprising circuit traces mapped to predetermined locations at the edge of the functional region; and
a regional circuit design, wherein the region circuit design is inserted into the functional region, and wherein circuit traces of the regional circuit design are mapped to the predetermined locations.

14. The customized PCB of claim 13, wherein the predetermined locations accommodate changing bit widths associated with varied regional circuit designs.

15. The customized PCB of claim 13, wherein the functional region includes reserve spacing to accommodate the maximum bit width of a regional circuit design.
